(19) United States
(12) Patent Application Publication
(10) Pub. No.: US 2026/0254333 A1
(43) Pub. Date: Aug. 27, 2026

(54) ELECTRIC MACHINE WITH TRANSITION ZONE FIELD WINDING

(71) Applicant: Gordon Abas GOODARZI, Rolling Hills, CA (US)

(72) Inventor: Gordon Abas GOODARZI, Rolling Hills, CA (US)

(21) Appl. No.: 19/062,750

(22) Filed: Feb. 25, 2025

(51) Int. Cl. H02K 21/04

(52) U.S. Cl. CPC H02K 21/046

(57) ABSTRACT

An electric machine may have an integrated rotor mechanically coupled with a shaft. The integrated rotor may include an axial rotor component mechanically integrated with a radial rotor component to have a common angular velocity. The integrated rotor may also include a wound rotor component. The electric machine may further include a stator assembly that may include an axial stator component, a radial stator component, and a transition stator component arranged at a first angle with respect to the axial stator component and at a second angle with respect to the radial stator component. The electric machine may include an integrated stator winding mechanically coupled with the radial stator, axial stator and transitional stator component. The electric machine may further include a field winding mechanically coupled with the integrated rotor and configured to magnetically interact with the transition stator component.

### TECHNICAL FIELD

Embodiments of the present disclosure generally relate to an electric machine, and more particularly to an electric machine having an integrated rotor.

### BACKGROUND

Electric machines, for example, electric motors and electric generators may be used for converting electrical energy into mechanical energy or vice versa. Electric motors are fundamental in powering a wide range of applications, from industrial machinery and transportation systems to household appliances and advanced robotics. Their versatility and efficiency make them useful in many practical applications.

Though electric motors may be designed in many ways with different configurations of rotors and stators, conventional motor designs face several limitations that hinder their performance in advanced and demanding use cases such as drones, robotics, vertical takeoff aviation, and electric vehicles (EVs). These challenges arise due to the inherent constraints of conventional motor systems.

Conventional motors can struggle to maintain efficiency across a wide range of operating conditions, such as low-speed high-torque or high-speed low-torque scenarios. This is particularly evident in electric vehicles (EVs), UAV and robotics. Inefficiency in field weakening and/or high-speed operations can generally lead to energy losses, reduced performance, and limited operational flexibility of the electrical machines.

There is thus a need for more efficient and/or effective electric machines that may provide a solution to the aforementioned problems.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1 is a cross-sectional view of an electric machine with a rotor mechanism configured in an inner rotating configuration, according to at least one embodiment of the present invention.

FIG. 2 is a cross-sectional view of an electric machine with a rotor mechanism configured in an outer rotating configuration, according to at least one embodiment of the present invention.

FIG. 3 illustrates a cross-sectional view of an electric machine with a transition mechanism, according to at least one embodiment of the present invention.

FIG. 4 depicts a transition stator component of the transition mechanism for an electric machine, according to at least one embodiment of the present invention.

FIG. 5 illustrates a cross-sectional view of an electric machine, according to at least one embodiment of the present invention.

FIG. 6 illustrates a cross-sectional view of an electric machine with a transition rotor and stator mechanism in an outer rotating configuration, according to at least one embodiment of the present invention.

FIG. 7 illustrates a cross-sectional view of an electric machine with a transition rotor mechanism in an inner rotating configuration, according to at least one embodiment of the present invention.

FIG. 8 illustrates a cross-sectional view of an electric machine with a dual integrated outer rotating rotor mechanism, according to at least one embodiment of the present invention.

FIG. 9 illustrates a cross-sectional view of an electric machine with an integrated inner rotating rotor, according to at least one embodiment of the present invention.

FIG. 10 illustrates a cross-sectional view of an electric machine with a hybrid wound rotor, according to at least one embodiment of the present invention.

FIG. 11 illustrates a cross-sectional view of an electric machine with a hybrid wound rotor incorporated into an integrated dual rotor, according to at least one embodiment of the present invention.

FIG. 12 illustrates a flowchart of a method of controlling an electric machine according to at least one embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes”, “such as”, “for instance”, and “for example” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

An electric machine may include a shaft having an axis of rotation, and an integrated rotor mechanically coupled with the shaft. The integrated rotor may include an axial rotor component and a radial rotor component. The axial rotor component may be mechanically integrated with the radial rotor component such that the axial rotor component and the radial rotor component have a common angular velocity. The electric machine may further include a stator assembly that includes an axial stator component, a radial stator component, and a transition stator component arranged at a first angle with respect to the axial stator component and at a second angle with respect to the radial stator component. The electric machine may further include a field winding mechanically coupled with the integrated rotor and configured to magnetically interact with the transition stator component.

An electric machine may include a shaft having an axis of rotation, and a first integrated rotor mechanically coupled with the shaft, the first integrated rotor comprising a first axial rotor component and a first radial rotor component. The electric machine may further include a second integrated rotor mechanically coupled with the shaft, the second integrated rotor that may include a second axial rotor component and a second radial rotor component. The electric machine may further include a first stator assembly comprising a first axial stator component, a first radial stator component and a first transition stator component arranged at a first angle with respect to the first axial stator component and at a second angle with respect to the first radial stator component. The electric machine may further include a second stator assembly comprising a second axial stator component, a second radial stator component and a second transition stator component arranged at a third angle with respect to the second axial stator component and at a fourth angle with respect to the second radial stator component. The electric machine may further include a first field winding mechanically coupled with the first integrated rotor and configured to magnetically interact with the first transition stator component. The electric machine may further include a second field winding mechanically coupled with the second integrated rotor and configured to magnetically interact with the second transition stator component.

A method of controlling an electric machine may include energizing a field winding mechanically coupled with an integrated rotor and configured to magnetically interact with a transition stator component disposed between an axial stator component and a radial stator component of a stator assembly; monitoring at least one electrical parameter of the energized field winding; and adjusting the at least one electrical parameter based at least in part on the monitoring.

The phases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B, and C together.

The term “a” or “an” entity refers to one or more of that entity. As such, the terms “a” (or “an”), “one or more” and “at least one” can be used interchangeably herein.

The term “automatic” and variations thereof, as used herein, refers to any suitable process or operation done without material human input when the process or operation may be performed. However, a process or operation can be automatic, even though performance of the process or operation uses material or immaterial human input, if the input is received before performance of the process or operation. Human input may be deemed to be material if such input influences how the process or operation is performed. As an example, human input that merely consents to the performance of the process or operation may be deemed to be immaterial.

The term “rotor” and variations thereof, as used herein, may refer to a rotating component of an electric machine.

The term “stator” and variations thereof, as used herein, may refer to a stationary component of an electric machine.

The term “magnetic flux” and variations thereof, as used herein, may refer to magnetic field passing through a specified area.

The term “magnetic field” and variations thereof, as used herein, may refer to the region of influence around a magnetic material or an electric current-carrying conductor where magnetic forces are exerted.

The term “air gap” and variations thereof, as used herein, may refer to a physical clearance or spacing between the rotor and the stator in an electric machine.

The term “windings” and variations thereof, as used herein, may refer to conductive elements, typically made of materials such as copper or aluminum, that are positioned on the stator, rotor, or both. These windings may interact with magnetic fields when electrical current passes through them.

The term “poles” and variations thereof, as used herein, may refer to regions of a magnetic field within the rotor, stator, or both, that possess distinct magnetic polarities (e.g., North and South). Poles may be created through the arrangement of windings or permanent magnets and significantly influence the torque production, speed characteristics, and operational efficiency of the electric machine.

The term “axis” and variations thereof, as used herein, may refer to a central line or rotational axis of the rotor within the electric machine. The axis of rotation may provide a reference for aligning components, defining rotational dynamics, and/or establishing an optimal electromagnetic interaction between the rotor and stator.

Although various embodiments are described with respect to an electric machine, it may be contemplated that the approaches of the various embodiments described herein are applicable to high torque electric machines for any suitable industrial application as required or recommended.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in this specification do not necessarily all refer to the same embodiment. Furthermore, the particular features, structures, or characteristics may be combined in any suitable manner in one or more embodiments.

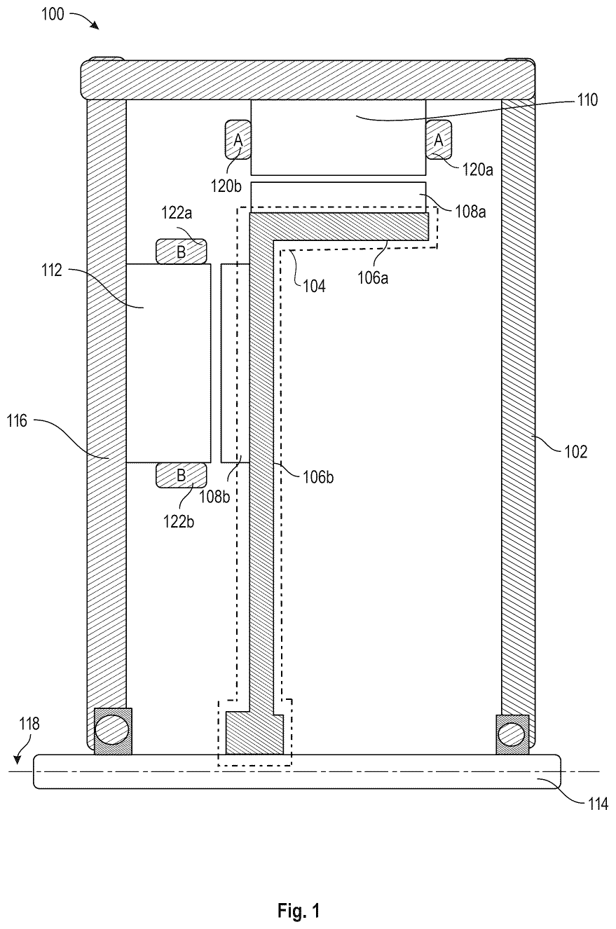

FIG. 1 depicts a cross-sectional view of an inner rotating electric machine 100, according to at least one embodiment of the present invention. The electric machine 100 may be adapted to generate mechanical power through a conversion of electrical energy.

In an exemplary scenario of the present invention, the electric machine 100 may include an energy converter, for example, a motor, that may be adapted to convert electrical energy into mechanical power. Alternatively, or in addition, the electric machine 100 may act as a generator, to convert mechanical power into electrical energy.

In a further scenario of the present invention, the electric machine 100 may include energy transformers that may be adapted to convert the electrical energy between different forms. The electric machine 100 may be adapted to convert energy for regulation of output power to match demands of specific applications. The electric machine 100 may be adapted to deliver high torque at low speeds for industrial applications. The electric machine 100 may be adapted to reduce output torque ripple and input current ripple, according to the embodiments of the present invention. Embodiments of the present invention may be intended to include or otherwise cover any suitable functionality of the electric machine 100, including known, related art, and/or later developed technologies.

The electric machine 100 may incorporate one or more features of, for example, a brushless Direct Current (DC) motor, a synchronous motor, a wound rotor synchronous, an induction motor, a stepper motor, a switched reluctance motor, a linear motor, a high-speed turbine generator, a reluctance synchronous motor, an axial flux motor, a hybrid stepper motor, a permanent magnet synchronous motor, an asynchronous motor, a doubly-fed induction generator, a permanent magnet motor, a radial flux motor, a flux-switching motor, a synchronous reluctance motor, a linear induction motor, a DC series motor, a DC shunt motor, a universal motor, a trapezoidal permanent magnet motor, a hysteresis motor, a crossed field motor, a segmented rotor motor, a variable reluctance motor, a low-speed high-torque motor, a piezoelectric motor, a ferrofluidic motor, transformers and so forth. Embodiments of the present invention may be intended to include or otherwise cover any suitable type of the electric machine 100, including known, related art, and/or later developed technologies.

According to embodiments of the present invention, the electric machine 100 may include an external housing 102. The external housing 102 may be adapted to enclose and/or protect internal components of the electric machine 100. The external housing 102 may further be adapted to dissipate heat generated during an operation and to provide a structural support for mounting the electric machine 100 in various applications. The external housing 102 may also be adapted to prevent the ingress of contaminants, such as dust and moisture, thereby enhancing the durability and reliability of the electric machine 100.

According to at least one embodiment of the present invention, the electric machine 100 may include an integrated rotor 104. The integrated rotor 104 may further include a radial rotor component 106a and an axial rotor component 106b. According to an embodiment of the present invention, the axial rotor component 106b may be arranged substantially perpendicular or with some angle to an axis of rotation 118 and the radial rotor component 106a may be arranged substantially parallel or with some angle to the axis of rotation 118.

According to an embodiment of the present invention, the axial rotor component 106b may be mechanically integrated with the radial rotor component 106a such that the axial rotor component 106b and the radial rotor component 106a may have a common angular velocity. In practice, components of the integrated rotor may not be perfectly rigid so that angular velocity may vary slightly during rotor acceleration or deceleration (e.g., a variance of less than 0.1%). Controllers may be configured to limit such variance and/or corresponding stresses in rotor components. Although not depicted in FIG. 1, the electric machine 100 may include an axial controller for axial components, a radial controller for radial components and/or a unified controller for both axial and radial components. In at least one embodiment of the present invention, the unified controller may supervise distinct axial and radial controllers.

The integrated rotor 104 may further include magnetic elements 108a-108b such as first magnetic elements 108a, and second magnetic elements 108b (hereinafter commonly referred to as the magnetic elements 108, or individually referred to as the first magnetic elements 108a, and second magnetic elements 108b). The first magnetic elements 108a may be arranged corresponding to the radial rotor component 106a of the integrated rotor 104. The second magnetic elements 108b may be arranged corresponding to the axial rotor component 106b. The magnetic elements 108 may be configured to generate magnetic fields in radial and/or axial directions. Examples of such magnetic elements 108 may include rare-earth or conventional magnets like neodymium (NdFeB), samarium-cobalt (SmCo) magnets, ferrite magnets, alnico magnets, electromagnets with coils wound around ferromagnetic cores, and so forth. Embodiments of the present invention may be intended to include or otherwise cover any suitable type of magnetic elements 108, including known, related art, and/or later developed technologies.

The electric machine 100 may further include a radial stator component 110 and an axial stator component 112. The radial stator component 110 and the axial stator component 112 may be part of a stator assembly. The stator assembly may be adapted to interact with the integrated rotor 104. According to an embodiment of the present invention, the radial stator component 110 may be arranged substantially parallel to the axis of rotation 118. According to an embodiment of the present invention, the axial stator component 112 may be arranged substantially perpendicular to the axis of rotation 118 of the electric machine 100.

According to the embodiments of the present invention, the radial rotor component 106a and the axial rotor component 106b of the integrated rotor 104 may be configured to interact with the stator assembly. The radial rotor component 106a may be configured to interact with the radial stator component 110 of the stator assembly. The axial rotor component 106b may be adapted in an inner rotating configuration. The axial rotor component 106b may be configured to interact with the axial stator component 112 of the stator assembly. The integrated rotor 104 may be mechanically coupled with the stator assembly in a predefined configuration that may define the relative positioning of the integrated rotor 104 and the stator assembly.

In an embodiment of the present invention, as shown in the FIG. 1, the predefined configuration may include an inner rotating configuration of the integrated rotor 104. The inner rotating configuration may include the radial stator component 110 of the stator assembly arranged to surround the integrated rotor 104 and the axial stator component 112 of the stator assembly may be positioned on one or both sides of the integrated rotor 104. In an embodiment of the present invention, in the inner rotating configuration, the radial stator component 110 may encircle the integrated rotor 104. The radial stator component 110 may include stator windings 120a-120b that may generate magnetic fields radially inward toward the integrated rotor 104. The axial stator component 112 may include stator windings 122a-122b that may generate the magnetic fields axially along the length of the integrated rotor 104.

The integrated rotor 104 may be mechanically coupled with a shaft 114 (also referred to as a central shaft) for transmitting rotational motion. The shaft 114 may act as a central axis for rotations of the integrated rotor 104. The shaft 114 may be arranged to support the integrated rotor 104 and to transmit mechanical power to an external system powered through the electric machine 100. In an exemplary scenario of the present invention, the integrated rotor 104 may be mechanically coupled with the shaft 114 through bearings. Embodiments of the present invention may include or otherwise cover any suitable type of mechanical coupling for the integrated rotor 104 and the shaft 114, including known, related art, and/or later developed technologies.

Further, in the inner rotating configuration as shown in the FIG. 1, the integrated rotor 104 may be positioned inside the stator assembly and may rotate corresponding to rotations of the shaft 114. For example, as shown in FIG. 1, the integrated rotor 104 may be disposed between the radial stator component 110, the axial stator component 112 and the shaft 114.

According to at least one embodiment of the present invention, the electric machine 100 may further include an end bell 116. The end bell 116 may be adapted to enclose and support one or both ends of the external housing 102. The end bell 116 may further be adapted to provide a structural integrity to the electric machine 100 and house components such as bearings for supporting the shaft 114. The end bell 116 may also be adapted to facilitate an alignment of the integrated rotor 104 with the stator assembly and to ensure proper sealing to prevent the ingress of contaminants, such as dust or moisture. In an embodiment of the present invention, the end bell 116 may include ventilation openings and/or channels to aid in cooling internal components of the electric machine 100. Embodiments of the present invention may be intended to include or otherwise cover any suitable design and/or configuration of the end bell 116, including known, related art, and/or later developed technologies.

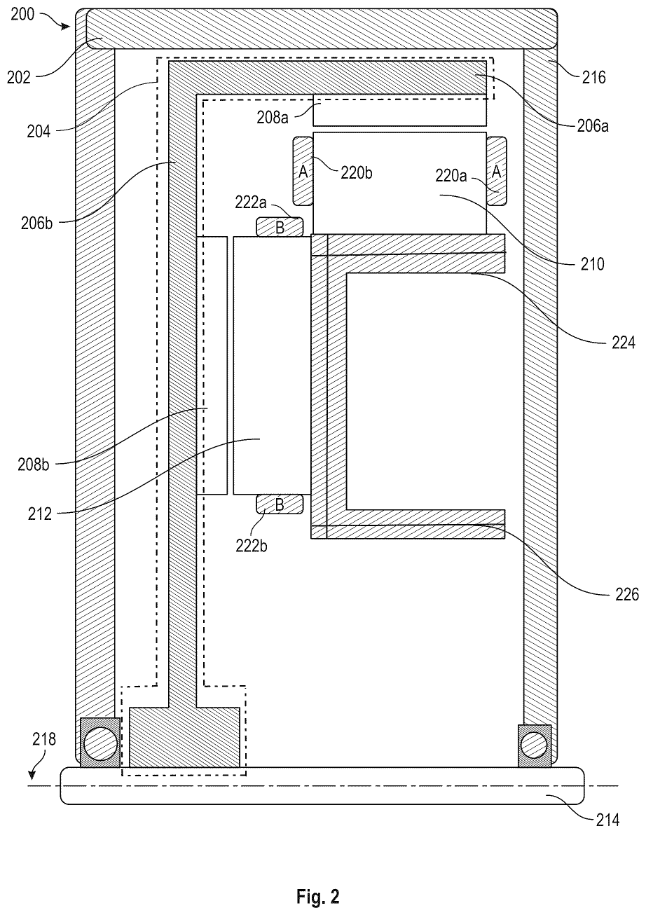

FIG. 2 illustrates a cross-sectional view of an outer rotating electric machine 200, according to at least one embodiment of the present invention. The electric machine 200 (FIG. 2) may be an example of the electric machine 100 (FIG. 1) adapted in an outer rotating configuration. The electric machine 200 may be adapted to function similar or nearly similar to the electric machine 100 and the components of the electric machine 200 may be similar or nearly similar to the components of the electric machine 100.

According to at least one embodiment of the present invention, the electric machine 200 may include an external housing 202. The external housing 202 (FIG. 2) may be an example of the external housing 102 (FIG. 1). According to at least one embodiment of the present invention, the integrated rotor 204 may be arranged inside the external housing 202. The integrated rotor 204 may include a radial rotor component 206a and an axial rotor component 206b. The integrated rotor 204, the radial rotor component 206a, and the axial rotor component 206b may be adapted in the outer rotating configuration. The external housing 202 may further include a first magnetic element 208a and a second magnetic element 208b, hereinafter referred to as the “magnetic elements 208” or “magnetic element 208”. The first magnetic element 208a and the second magnetic element 208 may be arranged corresponding to the radial rotor component 206a and the axial rotor component 206b, respectively. The magnetic elements 208 may be configured to generate magnetic fields in the axial direction and/or the radial direction. The magnetic elements 208 may be secured and/or bonded to the integrated rotor 204 by means such as solid or laminated magnetic steel.

The electric machine 200 may further include a stator assembly that may include a radial stator component 210 and an axial stator component 212, according to at least one embodiment of the present invention. The radial stator component 210, the axial stator component 212, the radial rotor component 206a and the axial rotor component 206b of the integrated rotor 204 may be configured to interact with the stator assembly. The radial rotor component 206a may be configured to interact with the radial stator component 210 of the stator assembly. The axial rotor component 206b may be configured to interact with the axial stator component 212 of the stator assembly.

The integrated rotor 204 may be mechanically coupled to the stator assembly in a predefined configuration such that the mechanical coupling may define the relative positioning of the integrated rotor 204 and the stator assembly. The predefined configuration may be an outer rotating configuration of the integrated rotor 204. The outer rotating configuration may incorporate the radial stator component 210 of the stator assembly that may be arranged inside the integrated rotor 204. Further, in the outer rotating configuration, the axial stator component 212 of the stator assembly may be positioned along a length of the integrated rotor 204 situated at one or both ends of the integrated rotor 204.

Further, in the outer rotating configuration, the integrated rotor 204 may be positioned outside the stator assembly, for example, the stator assembly may be disposed between the rotor 204 and the shaft 214. In an embodiment of the present invention, in the outer rotating configuration, the axial stator component 212 may be disposed inside the integrated rotor 204 and may include windings 220a-220b and windings 222a-222b that may be configured to generate the magnetic fields radially outward towards the integrated rotor 204.

According to at least one embodiment of the present invention, the electric machine 200 may include a shaft 214 that may be positioned at a center of the electric machine 200. The radial stator component 210 of the stator assembly may include a radial stator arranged to face at least one flat surface of the integrated rotor 204 to generate the axial magnetic field. The axial stator component 212 of the stator assembly may include an axial stator arranged concentrically with an axis of rotation 218 of the integrated rotor 204 to generate a radial magnetic field. Further, the radial stator component 210 and the axial stator component 212 of the stator assembly, may be configured with respective windings 220a-220b, and windings 222a-222b for each of the radial stator component 210 and the axial stator component 212. In some embodiments of the present invention, the radial stator component 210 and the axial stator component 212 may be positioned orthogonally to each other. The radial stator component 210 may be arranged around a cylindrical surface of the integrated rotor 204 and may be disposed between the radial rotor component 206a of the integrated rotor and an end bell 216 of the electric machine 200, according to at least one embodiment of the present invention.

According to at least one embodiment of the present invention, the electric machine 200 may include one or more cooling system 224. The cooling system 224 may include cold plates 226. The electric machine 200 may include additional cooling mechanisms integrated with the cooling system 224, such as heat sinks, thermoelectric coolers, or forced-air fans, to further enhance a cooling performance of the electric machine 200.

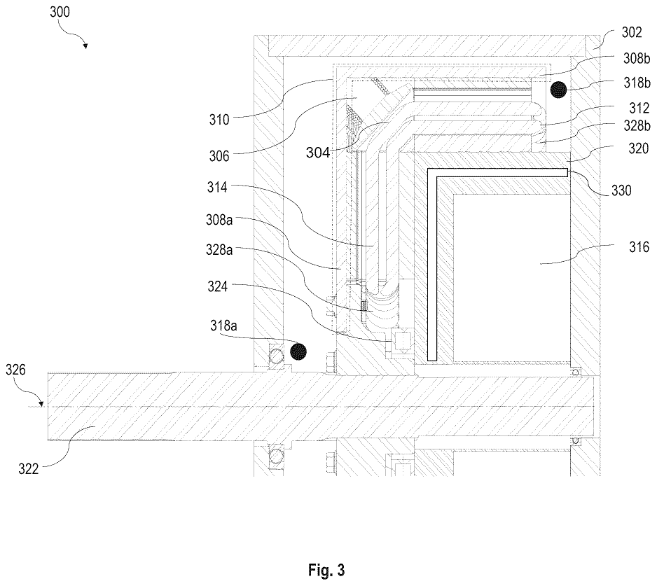

FIG. 3 illustrates a cross-sectional view of an electric machine 300, according to at least one embodiment of the present invention. The electric machine 300 (FIG. 3) may be an example of the electric machine 100 (FIG. 1) or the electric machine 200 (FIG. 2).

According to at least one embodiment of the present invention, the electric machine 300 may incorporate a transition mechanism. The transition mechanism may include a transition stator component 304 and field windings 306 that may be arranged inside an external housing 302 of the electric machine 300.

The transition stator component 304 may be positioned between at least one rotor-side component such as an axial rotor excitation winding component 308a and a radial rotor component 308b of an integrated rotor 310, according to an embodiment of the present invention. In an embodiment of the present invention, the transition stator component 304 may be positioned concentrically with an axis of rotation 326 of the integrated rotor 310 and may feature an annular structure that may provide structural stability and/or may support thermal management of the electric machine 300.

According to the embodiment of the present invention, the field windings 306 may be mechanically coupled with the integrated rotor 310 and configured to magnetically interact with the transition stator component 304. Further, the field windings 306 may be disposed between the radial rotor component 308b and a shaft 322. According to an embodiment of the present invention, the field windings 306 may be electrically coupled with some or all poles in series or parallel. In an exemplary embodiment of the present invention, the transition stator component 304 may be coupled with the field windings 306 (as shown in the FIG. 3) to generate hybrid magnetic fields that align with the operational characteristics of the radial rotor component 308b and/or the axial rotor excitation winding component 308a of the integrated rotor 310.

According to an embodiment of the present invention, the field windings 306 may be configured to be energized with a high frequency field excitation magnetically coupled supply 324 having the at least one rotor-side component. According to an embodiment of the present invention, the high frequency field excitation magnetically coupled supply 324 may alternatively be a power pick-up slip rings interface. According to the embodiments of the present invention, the energized field windings 306 may further be controlled by a dedicated controller or a unified controller 316 to optimize the performance of the electric machine 300.

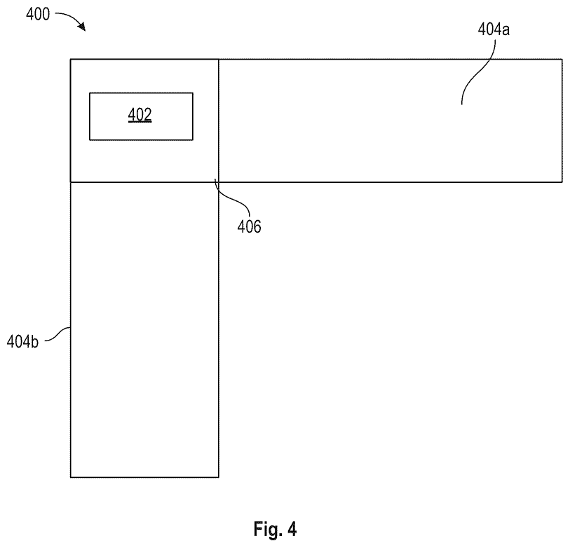

The transition stator component 304 may be disposed at an angle with respect to the radial rotor component 308b and/or the axial rotor excitation winding component 308a. The transition stator component 304 may be arranged to mechanically integrate the axial rotor excitation winding component 308a and the radial rotor component 308b into the integrated rotor 310. The transition stator component 304 may provide a magnetic interface to enable an angular shift to each of the axial rotor excitation winding component 308a and the radial rotor component 308b of the integrated rotor 310. The transition stator component 304 may be composed of materials with magnetic and non-magnetic properties. A working of the transition stator component 304 may further be explained in conjunction with the FIG. 4.

The integrated rotor 310 may further be mechanically coupled with a radial stator component 312 and an axial stator component 314. The integrated rotor 310 may be disposed of in the predefined configuration that may define the relative positioning of the integrated rotor 310 with the radial stator component 312 and the axial stator component 314.

In an embodiment of the present invention, as shown in the FIG. 3, the predefined configuration may include the outer rotating configuration of the integrated rotor 310 (similar to the outer rotating configuration as shown in the FIG. 2). The outer rotating configuration may include the radial stator component 312 and the axial stator component 314 that may be arranged beneath the integrated rotor 310. Further, the radial stator component 312 and the axial stator component 314 may be positioned along the length of the integrated rotor 310. According to an embodiment of the present invention, the axial rotor excitation winding component 308a may be mechanically integrated with the radial rotor component 308b such that the axial rotor excitation winding component 308a and the radial rotor component 308b may have a common angular velocity. The axial rotor excitation winding component 308a and the radial rotor component 308b may further include integrated windings 328a-328b.

In an exemplary embodiment of the present invention, the radial stator component 312, the axial stator component 314, and the transition stator component 304 may be configured with the integrated windings 328a-328b for respective control of torque generation with the axial rotor excitation winding component 308a, and/or the radial rotor component 308b.

According to at least one embodiment of the present invention, the electric machine 300 may include the unified controller 316. The unified controller 316 may be configured to supervise an axial controller 318a corresponding to the axial rotor excitation winding component 308a and/or a radial controller 318b corresponding to the radial rotor component 308a. The unified controller 316 may be configured to control the axial controller 318a and/or the radial controller 318b to operate in harmony for achieving an integration of radial and axial magnetic fields.

The radial controller 318b may be configured to manage the operation of the radial rotor component 308b. The radial controller 318b may further be configured to regulate the current supplied to the radial rotor component 308b for the generation of magnetic fields. The radial controller 318b may further be configured to monitor the torque and/or rotational speed of the radial rotor component 308b. Based on the monitored torque and/or rotational speed, the radial controller 318b may adjust its operation to maintain an efficient and/or effective performance of the electric machine 300.

Further, the axial rotor excitation winding component 308a may be configured to generate axial magnetic fields that may complement the radial rotor component 308b. The axial controller 318a may further be configured to regulate an alignment and distribution of axial magnetic flux within the electric machine 300, thereby enhancing an operational efficiency. The axial controller 318a may dynamically balance the magnetic flux between the axial rotor excitation winding component 308a and the radial rotor component 308b to enable a uniform load distribution and consistent performance of the electric machine 300.

According to at least one embodiment of the present invention, the electric machine 300 may include one or more cooling system(s) 320. The cooling system 320 (FIG. 3) may be an example of the cooling system 224 (FIG. 2). The cooling system 320 may be positioned adjacent to one or more of the radial stator component 312 and the axial stator component 314 to facilitate an efficient heat dissipation. The cooling system 320 may be thermally coupled with the stator windings and configured to transfer heat generated during operation of the electric machine 300 to a cooling medium. The cooling medium may include liquid coolant, refrigerants, or air circulated through the cooling system 320. Embodiments of the present invention may be intended to include or otherwise cover any suitable cooling medium for the electric machine 300, including known, related art, and/or later developed technologies.

In an exemplary embodiment of the present invention, the cooling system 320 may include integrated cooling channels to enhance heat transfer efficiency. The cooling channels may be designed to circulate the cooling medium uniformly across the surface area of the cooling system 320 for maintaining a consistent temperature control of the stator assembly and/or the integrated rotor 310.

The cooling system 320 may include cold plates 330, in an embodiment of the present invention. The cold plates 330 (FIG. 3) may be an example of the cold plates 226 (FIG. 2). The cold plates 330 may be used as mechanical integration of the stators into the housing 302. The cold plates 330 may be installed adjacent to one or more of the radial stator component 312 and the axial stator component 314 to facilitate an efficient and/or effective heat dissipation. The cold plates 330 may be fabricated from a thermally conductive material such as aluminum, copper, composite materials, and so forth. Embodiments of the present invention may be intended to include or otherwise cover any suitable thermally conductive material for the cold plates 330, including known, related art, and/or later developed technologies.

The electric machine 300 may include additional cooling mechanisms integrated with the cooling system 320, such as heat sinks, thermoelectric coolers, or forced-air fans, to further enhance the cooling performance of the electric machine 300. Such configurations may ensure the reliable operation of the electric machine 300, even under high power or prolonged operational conditions. Embodiments of the present invention may be intended to include or otherwise cover any suitable cooling mechanisms for the electric machine 300, including known, related art, and/or later developed technologies.

Further, the high frequency field excitation magnetically coupled supply 324 may be designed to transfer electrical power efficiently to the rotating components of the electric machine 300 such as the integrated rotor 310. The high frequency field excitation magnetically coupled supply 324 may be designed to maintain a reliable operation of the integrated rotor 310 with minimal energy loss. The high frequency field excitation magnetically coupled supply 324 may include elements such as conductive rings, brushes and/or other contact mechanisms that may maintain a stable electrical connection during high-speed rotations performed by the electrical machine 300.

In an embodiment of the present invention, an inner configuration and an outer configuration of the electric machine 300 may be similar to the inner configuration and the outer configuration as discussed above for the electric machines 100 and 200.

FIG. 4 depicts a transition stator component 402 of the electric machine 400. The electric machine 400 (FIG. 4) may be an example of the electric machine 100 (FIG. 1). The transition stator component 402 may be adapted to function as an intermediary stator component facilitating interaction between the axial rotor component 404a and the radial rotor component 404b of the integrated rotor 406. The transition stator component 402 may be disposed at an angle with respect to the axial rotor component 404a and the radial rotor component 404b such as the transition stator component may be configured to magnetically integrate with the axial rotor component 404a and the radial rotor component 404b of the integrated rotor 406. The transition stator component 402 may further be configured to enhance magnetic flux linkage and improve torque generation by creating a seamless transition of magnetic fields between the radial and axial directions.

In an embodiment of the present invention, the inner configuration and the outer configuration of the electric machine 400 may be similar to the inner configuration and the outer configuration as discussed above for the electric machines 100, 200, and 300.

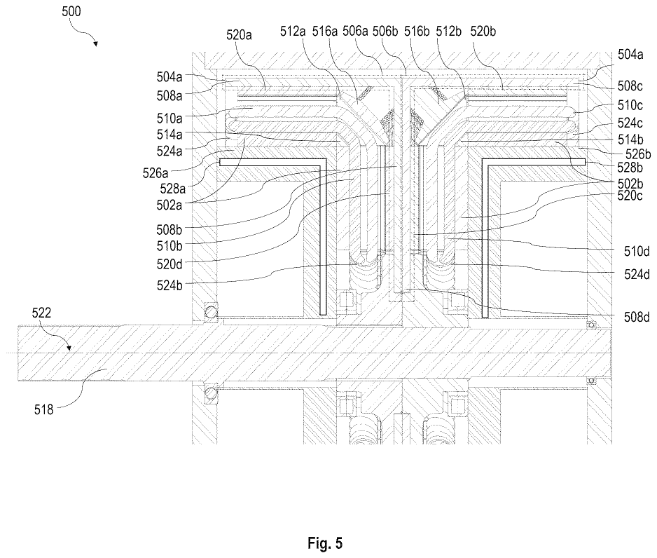

FIG. 5 illustrates a cross-sectional view of an electric machine 500, according to at least one embodiment of the present invention. The electric machine 500 (FIG. 5) may be an example of the electric machine 100 (FIG. 1). The electric machine 500 may be a dual configuration of the electric machine 300 (FIG. 3). Further, the dual configuration may be achieved by means such as, but not limited to, welding, bolting, interlocking, and so forth. Embodiments of the present invention are intended to include or otherwise cover any suitable means, including known, related art, and/or later developed technologies, for the dual configuration of the electric machine 300 for achievement of the electric machine 500.

The electric machine 500 may include a first stator assembly 502a and a second stator assembly 502b to generate the magnetic field in the electric machine 500. The electric machine 500 may further include a dual integrated rotor mechanism such as a first rotor mechanism 504a and a second rotor mechanism 504b. The first rotor mechanism 504a may include a first integrated rotor 506a that may be configured to interact with the first stator assembly 502a. The first integrated rotor 506a may include a first radial rotor component 508a and a first axial component 508b. The first radial rotor component 508a and the first axial component 508b may be mechanically integrated to have a substantially same or similar rotation speed and/or position (e.g., to within a design tolerance).

The first radial rotor component 508a may be configured to interact with the first stator 510a of the first stator assembly 502a. The first axial component 508b may be configured to interact with a second stator 510b of the at least first stator assembly.

The first integrated rotor 506a may be mechanically coupled to the at least first stator assembly 502a in the predefined configuration that defines the relative positioning of the first integrated rotor 506a and the at least first stator assembly 502a.

The first rotor mechanism 504a may further include a first transition mechanism 512a. The first transition mechanism 512a may include a first transition stator component 514a and a first field winding 516a positioned between the first radial rotor component 508a and the first axial rotor component 508b of the first integrated rotor 506a. The first transition stator component 514a may be disposed at an angle with respect to the first radial rotor component 508a and/or the first axial rotor component 508b. The first transition stator component 514a may be mechanically integrated with the first radial rotor component 508a and the first axial rotor component 508b into the first integrated rotor 506a. The first field winding 516a may be energized with a high frequency field excitation magnetically coupled supply having the at least one rotor-side component.

The second integrated rotor 506b may be configured to interact with the second stator assembly 502b. The second integrated rotor 506b may include the second radial rotor component 508c that may be configured to interact with a third stator 510c of the second stator assembly 502b. The second integrated rotor 506b may further include the second axial rotor component 508c configured to interact with a fourth stator 510d of the second stator assembly 502b. The second integrated rotor 506b may be mechanically coupled with the second stator assembly 502b in a predefined configuration that may define the relative positioning of the second integrated rotor 506b and the second stator assembly 502b.

The second rotor mechanism 504b may further include the second transition mechanism 512b. The second transition mechanism 512b may include a second transition stator component 514b and a second field winding 516b that may be positioned between the second radial rotor component 508c and the second axial rotor component 508d of the second integrated rotor 506b. The second transition stator component 514b may be disposed at an angle with respect to both the second radial 508c component and the second axial rotor component 508d to mechanically integrate the second radial rotor component 508c and the second axial rotor component 508d into the second integrated rotor 506b. The second field winding 516b may be mechanically coupled with the second integrated rotor 506b and configured to magnetically interact with the second transition stator component 514b.

The electric machine 500 may further include a shaft 518 mechanically coupled with the first integrated rotor 506a for transmitting rotational motion and the second integrated rotor 506b for transmitting rotational motion. The shaft 518 may have an axis of rotation 522.

In an exemplary embodiment of the present invention, the first stator 510a and the second stator 510b may be configured with the integrated windings 524a-524b for respective control of torque generation with the first radial rotor component 508a and the first axial component 508b. In an exemplary embodiment of the present invention, the third stator 510c and fourth stator 510d may be configured with the integrated windings 524c-524d for respective control of torque generation with the second radial rotor component 508c and the second axial rotor component 508d.

The electric machine 500 may further include magnetic elements 520a-520d such as first magnetic elements 520a, second magnetic elements 520 b, third magnetic elements 520c, and fourth magnetic elements 520d (hereinafter commonly referred to as the magnetic elements 520, or individually referred to as the first magnetic elements 520a, the second magnetic elements 520b, the third magnetic elements 520c, and the fourth magnetic elements 520d). The magnetic elements 520 may be configured to generate magnetic fields in radial and/or axial directions.

According to at least one embodiment of the present invention, the electric machine 500 may include one or more cooling system(s) 526a-526b. The cooling system 526 may include cold plates 528a-528b. The electric machine 500 may include additional cooling mechanisms integrated with the cooling system 526, such as heat sinks, thermoelectric coolers, or forced-air fans, to further enhance the cooling performance of the electric machine 500. The cooling system 526a-526b (FIG. 5) may be an example of the cooling system 320 (FIG. 3). The cold plates 528a-528b (FIG. 5) may be an example of the cold plates 330 (FIG. 3).

In an embodiment of the present invention, the inner configuration and the outer configuration of the electric machine 500 may be similar to the inner configuration and the outer configuration as discussed above for the electric machines 100, 200, 300, and 400.

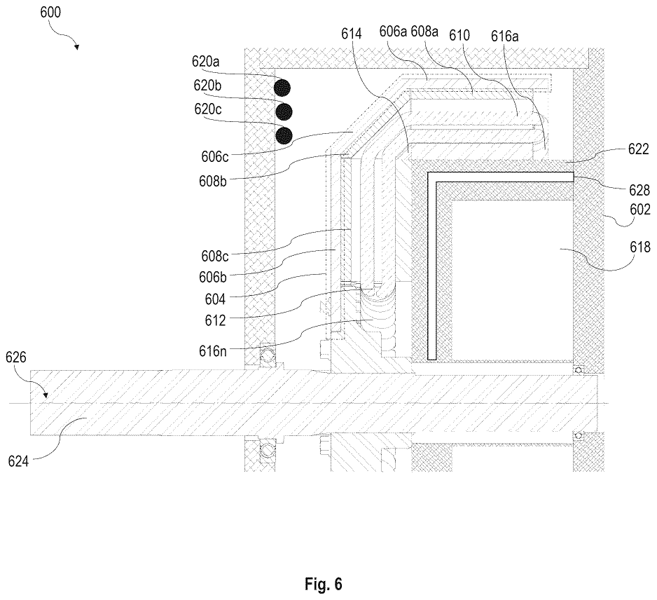

FIG. 6 illustrates a cross-sectional view of an electric machine 600 with a transition rotor and stator mechanism in an outer rotating configuration, according to at least one embodiment of the present invention. The electric machine 600 (FIG. 6) may be an example of the electric machine 100 (FIG. 1).

According to an embodiment of the present invention, the electric machine 600 may include an external housing 602. The external housing 602 (FIG. 6) may be an example of the external housing 102 (FIG. 1).

According to at least one embodiment of the present invention, the electric machine 600 may further include an integrated rotor 604. The integrated rotor 604 may further include a radial rotor component 606a, an axial rotor component 606b, and a transition rotor component 606c. According to an embodiment of the present invention, the axial rotor component 606b may be arranged substantially perpendicular to an axis of rotation 626 and the radial rotor component 606a may be arranged substantially parallel to the axis of rotation 626. The transition rotor component 606c may be arranged at a first angle with respect to the axial rotor component 606b and at a second angle with respect to the radial rotor component 606a. In one or more embodiments of the present invention, the first angle and the second angle may be greater than 0 degrees and less than 60 degrees. The magnetic elements 608a-608c may be shifted in a range from 0 degrees to 60 degrees and the transition may be accommodated by the magnetic elements 608a-608c but the radial rotor component 606a, the axial rotor component 606b, or the transition rotor component 606c may be perpendicular or may have some angle with respect to the shaft 624. In other embodiments of the present invention, the first angle and the second angle may be greater than 60 degrees and less than 90 degrees. Embodiments of the present invention are intended to include or otherwise cover any suitable magnitude of the first angle and the second angle.

According to an embodiment of the present invention, the radial rotor component 606a, the axial rotor component 606b, and the transition rotor component 606c may be mechanically and/or magnetically integrated such that the axial rotor component 606b, the radial rotor component 606a, and the transition rotor component 606c may have a common angular velocity.

In at least one embodiment of the present invention, the axial rotor component 606b may be arranged at a third angle that may be different from perpendicular to the axis of rotation 626 to reduce ripple (e.g., torque ripple, current ripple). Further, the radial rotor 606a component may be arranged at a fourth angle that may be different from parallel to the axis of rotation 626 to reduce the ripple.

In one or more embodiments of the present invention, the third angle and the fourth angle may be greater than 0 degrees and less than 30 degrees. In other embodiments of the present invention, the third angle and the fourth angle may be greater than 30 degrees and less than 60 degrees. Embodiments of the present invention are intended to include or otherwise cover any suitable magnitude of the third angle and the fourth angle.

The integrated rotor 604 may further include magnetic elements 608a-608c such as first magnetic elements 608a, second magnetic elements 608b, and third magnetic elements 608c (hereinafter commonly referred to as the magnetic elements 608, or individually referred to as the first magnetic elements 608a, the second magnetic elements 608b, and third magnetic elements 608c). The first magnetic elements 608a may be arranged corresponding to the radial rotor component 606a of the integrated rotor 604. The second magnetic elements 608b may be arranged corresponding to the axial rotor component 606b. The third magnetic elements 608c may be arranged corresponding to the transition rotor component 606c of the integrated rotor 604. The magnetic elements 608 may be configured to generate magnetic field in radial and/or axial directions. The first magnetic elements 608a, and the second magnetic elements 608b, may be shifted in an electrical phase ranging from 0 degrees to 60 degrees with the third magnetic elements 608c allowing a proper interface accommodating the phase shift.

The electric machine 600 may further include a radial stator component 610, an axial stator component 612, and a transitional stator component 614. The radial stator component 610, the axial stator component 612, and the transitional stator component 614 may combinedly be referred to as the stator assembly. The axial stator component 612, the transitional stator component 614 and the radial stator component 610 may further be configured with independent windings 616a-616n for respective control of torque generation with the axial rotor component 612 and the radial rotor component 610 of the integrated rotor 604. Component such as, the radial stator component 610, the axial rotor component 612, and the transitional stator component 614 may have the independent windings 616a-616n controlled by independent controllers. Alternatively, or in addition, two or three of the radial stator component 610, the axial rotor component 612, and the transitional stator component 614 may have a single integrated winding controlled by a unified controller.

The stator assembly may be adapted to interact with the integrated rotor 604. According to an embodiment of the present invention, the radial stator component 610 may be arranged substantially parallel to the axis of rotation 626. According to a further embodiment of the present invention, the axial stator component 612 may be arranged substantially perpendicular to the axis of rotation 626 of the electric machine 600. According to the embodiments of the present invention, the stator assembly may be configured to interact with the integrated rotor 604 such as the transitional stator component 614 may be arranged substantially parallel to the transition rotor component 606c.

The electric machine 600 may further include a unified controller 618 that may be arranged to control the operations of the radial rotor component 606a, the axial rotor component 606b, and/or the transition rotor component 606c, according to an embodiment of the present invention. The unified controller 618 (FIG. 6) may be an example of the unified controller 316 (FIG. 3), according to the embodiments of the present invention.

In some embodiments of the present invention, the unified controller 618 may be configured to supervise sub-controllers 620a-620c such as, a radial controller 620a, an axial controller 620b, and a transition controller 620c to control the operations of the radial rotor component 606a, the axial rotor component 606b, and/or the transition rotor component 606c, respectively.

The electric machine 600 may include one or more cooling system(s) 622. The cooling system 622 (FIG. 6) may be an example of the cooling system 320 (FIG. 3). The cooling system 622 may be positioned adjacent to one or more of the radial stator component 610, the axial stator component 612, and/or the transition stator component 614 to facilitate efficient heat dissipation.

The electric machine 600 may further include a shaft 624 that may be concentrically arranged along the central axis of the electric machine 600. The shaft 624 may be configured to facilitate a transfer of mechanical power generated by the integrated rotor 604 to an external load and/or a connected system.

According to at least one embodiment of the present invention, the electric machine 600 may include a cooling system 622. The cooling system 622 may include cold plates 628. The electric machine 600 may include additional cooling mechanisms integrated with the cooling system 622, such as heat sinks, thermoelectric coolers, or forced-air fans, to further enhance the cooling performance of the electric machine 600.

In an embodiment of the present invention, the inner configuration and the outer configuration of the electric machine 600 may be similar to the inner configuration and the outer configuration as discussed above for the electric machines 100, 200, 300, 400, and 500.

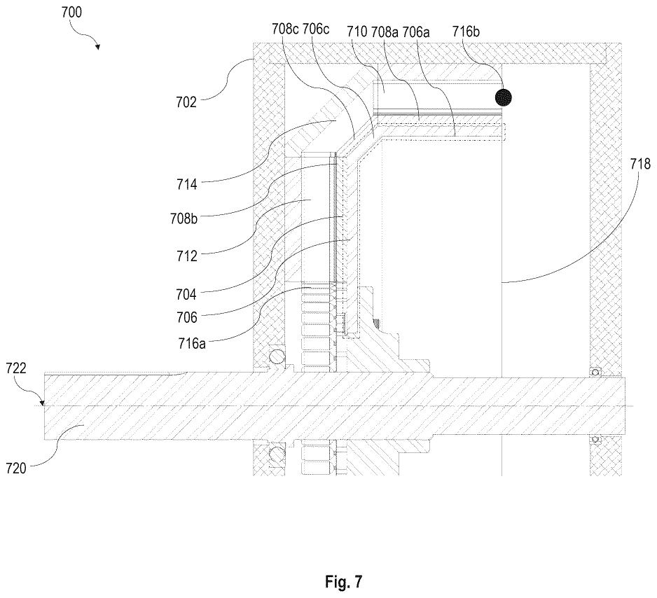

FIG. 7 illustrates a cross-sectional view of the electric machine 700 with the transition rotor mechanism in the inner rotating configuration, according to at least one embodiment of the present invention. In such an embodiment of the present invention, a radial rotor component 706a, an axial rotor component 706b, and a transition rotor component 706c of an integrated rotor 704 may be arranged in an external housing 702 underneath a radial stator component 710, an axial stator component 712, a transitional stator component 714. The components of the electric machine 700 such as magnetic elements 708a-708c, independent windings 716a-716n, the unified controller 718, and/or the shaft 720 may be arranged to function in a similar or nearly similar manner as described in aforementioned embodiments of the present invention. The shaft 720 may have an axis of rotation 722.

In an embodiment of the present invention, the inner configuration and the outer configuration of the electric machine 700 may be similar to the inner configuration and the outer configuration as discussed above for the electric machines 100, 200, 300, 400, 500, and 600.

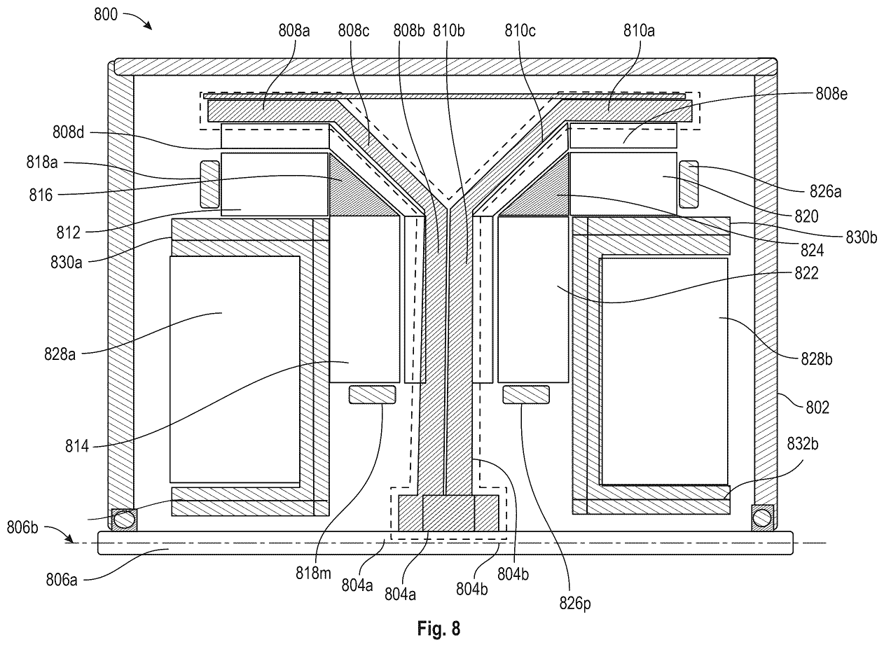

FIG. 8 illustrates a cross-sectional view of an electric machine 800 with a dual integrated outer rotating rotor mechanism, according to at least one embodiment of the present invention. The electric machine 800 may be a dual configuration of the electric machine 600 (FIG. 6) with the transition rotor and stator mechanism in the outer rotating configuration. Further, the dual configuration may be achieved by means such as, but not limited to, welding, bolting, interlocking, and so forth. Embodiments of the present invention are intended to include or otherwise cover any suitable means, including known, related art, and/or later developed technologies for achievement of the electric machine 800. The electric machine 800 (FIG. 8) may be an example of the electric machine 100 (FIG. 1), and some components of the electric machine 800 (FIG. 8) may function similar or nearly similar to the components of the electric machine 100 (FIG. 1). The electric machine 800 may include an external housing 802 that may be an example of the external housing 102 (FIG. 1).

The electric machine 800 may further include a first integrated rotor 804a and a second integrated rotor 804b that may be arranged inside the external housing 802. According to at least one embodiment of the present invention, the first integrated rotor 804a and the second integrated rotor 804b may be mechanically coupled with a shaft 806. The shaft 806a may be co-centrically arranged along an axis of rotation 806b of the electric machine 800 to enable the efficient transfer of the mechanical energy generated by the first integrated rotor 804a and a second integrated rotor 804b to the external loads and/or the connected systems.

According to at least one embodiment of the present invention, the first integrated rotor 804a may include a first radial rotor component 808a, a first axial rotor component 808b, and a first transition rotor component 808c. According to an embodiment of the present invention, the first axial rotor component 808b may be arranged substantially perpendicular to the axis of rotation 806b, and the first radial rotor component 808a may be arranged substantially parallel to the axis of rotation 806b. The first transition rotor magnet component 808c may be arranged at a first angle with respect to the first axial rotor component 808b and at a second angle with respect to the radial rotor component 808a. In one or more embodiments of the present invention, the first angle and the second angle may be greater than 0 degrees and less than 60 degrees. In other embodiments of the present invention, the first angle and the second angle may be greater than 60 degrees and less than 90 degrees. Embodiments of the present invention may be intended to include or otherwise cover any suitable magnitude of the first angle and the second angle.

According to an embodiment of the present invention, the first radial rotor component 808a, the first axial rotor component 808b, and the first transition rotor component 808c may be mechanically and/or magnetically integrated such as the first radial rotor component 808a, the first axial rotor component 808b, and the first transition rotor component 808c may have a common angular velocity.

According to an embodiment of the present invention, the first radial rotor component 808a, the first axial rotor component 808b, and the first transition rotor component 808c may be attached with a first rotor magnet 808d. The first rotor magnet 808d may be a first unified magnet that may be having a first axial magnet component, a first transition magnet component, and a first radial magnet component, in an embodiment of the present invention. In another embodiment of the present invention, the first rotor magnet 808d may include a first set of individual magnets that may include the first axial magnet component, the first transition magnet component and the first radial magnet component.

According to at least one embodiment of the present invention, the second integrated rotor 804b may include a second radial rotor component 810a, a second axial rotor component 810b, and a second transition rotor component 810c. According to an embodiment of the present invention, the second axial rotor component 810b may be arranged substantially perpendicular to the axis of rotation 806b, and the second radial rotor component 810a may be arranged substantially parallel to the axis of rotation 806b. The second transition rotor component 810c may be arranged at a third angle with respect to the second axial rotor component 810b and at a fourth angle with respect to the second radial rotor component 810a. In one or more embodiments of the present invention, the third angle and the fourth angle may be greater than 0 degrees and less than 60 degrees. In other embodiments of the present invention, the third angle and the fourth angle may be greater than 60 degrees and less than 90 degrees. Embodiments of the present invention are intended to include or otherwise cover any suitable magnitude of the third angle and the fourth angle.

According to an embodiment of the present invention, the second radial rotor component 810a, the second axial rotor component 810b, and the second transition rotor component 810c may be mechanically and/or magnetically integrated such the second radial rotor component 810a, the second axial rotor component 810b, and the second transition rotor component 810c may have a common angular velocity.

According to an embodiment of the present invention, the second radial rotor component 810a, the second axial rotor component 810b, and the second transition rotor component 810c may be attached with a second rotor magnet 808e. The second rotor magnet 808e may be a second unified magnet that may be having a second axial magnet component, a second transition magnet component, and a second radial magnet component, in an embodiment of the present invention. In another embodiment of the present invention, the second rotor magnet 808e may include a second set of individual magnets that may include the second axial magnet component, the second transition magnet component, and the second radial magnet component.

The electric machine 800 may further include a first radial stator component 812, a first axial stator component 814, and a first transitional stator component 816. The first radial stator component 812, the first axial stator component 814, and the first transitional stator component 816 may combinedly be referred to as a first stator assembly. The first radial stator component 812, the first axial stator component 814, and the first transitional stator component 816 may further be configured with a first set of independent windings 818a-818m for respective control of torque generation with the first radial rotor component 808a, the first axial rotor component 808b of the first integrated rotor 804a.

The first stator assembly may be adapted to interact with the first integrated rotor 804a. According to an embodiment of the present invention, the first radial stator component 812 may be arranged substantially parallel to the axis of rotation 806b. According to a further embodiment of the present invention, the first axial stator component 814 may be arranged substantially perpendicular to the axis of rotation 806b of the electric machine 800. According to the embodiments of the present invention, the first stator assembly may be configured to interact with the first integrated rotor 804a such as the first transitional stator component 816 may be arranged substantially parallel to the first transition rotor component 808c.

The electric machine 800 may further include a second radial stator component 820, a second axial stator component 822, and a second transitional stator component 824. The second radial stator component 820, the second axial stator component 822, and the second transitional stator component 824 may combinedly be referred to as a second stator assembly. The second radial stator component 820, the second axial stator component 822, and the second transitional stator component 824 may further be configured with a second set of independent windings 826a-826p for respective control of torque generation with the second radial rotor component 810a, the second axial rotor component 810b of the second integrated rotor 804b.

The second stator assembly may be adapted to interact with the second integrated rotor 804b. According to an embodiment of the present invention, the second radial stator component 820 may be arranged substantially parallel to the axis of rotation 806b. According to a further embodiment of the present invention, the second axial stator component 822 may be arranged substantially perpendicular to the axis of rotation 806b of the electric machine 800. According to the embodiments of the present invention, the second stator assembly may be configured to interact with the second integrated rotor 604b such as the second transitional stator component 824 may be arranged substantially parallel to the second transition rotor component 810c.

According to at least one embodiment of the present invention, the first axial rotor component 808b may be arranged at a fifth angle that may be different from perpendicular to the axis of rotation 806b to reduce the ripple. Similarly, the first radial rotor component 808a may be arranged at a sixth angle that may be different from parallel to the axis of rotation 806b to reduce the ripple. Further, the second axial rotor component 810b may be arranged at a seventh angle that may be different from perpendicular to the axis of rotation 806b to reduce ripple. Similarly, the second radial rotor component 810a may be arranged at an eighth angle that may be different from parallel to the axis of rotation 806b to reduce the ripple.

In one or more embodiments of the present invention, the fifth angle, the sixth angle, the seventh angle, and/or the eighth angle may be greater than 0 degrees and less than 60 degrees. In other embodiments of the present invention, the fifth angle, the sixth angle, the seventh angle, and/or the eighth angle may be greater than 30 degrees and less than 60 degrees. Embodiments of the present invention are intended to include or otherwise cover any suitable magnitude of the fifth angle, the sixth angle, the seventh angle, and/or the eighth angle.

The electric machine 800 may further include a first unified controller 828a and a second unified controller 828b. The first unified controller 828a and a second unified controller 828b may be adapted to function individually to control the operations of the first integrated rotor 804a, and the second integrated rotor 804b, according to an embodiment of the present invention. The first unified controller 828a and a second unified controller 828b may be physically non-distinctive and adapted to function in a unified manner to control the operations of the first integrated rotor 804a, and the second integrated rotor 804b. The first unified controller 828a and/or a second unified controller 828b may further be configured to function similarly or nearly similarly to the unified controller 316 (FIG. 3).

The electric machine 800 may further include a first cooling system 830a and a second cooling system 830b. The first cooling system 830a and/or the second cooling system 830b (FIG. 8) may be an example of the cooling system 320 (FIG. 3). The first cooling system 830a and/or the second cooling system 830b may include cold plates 832a-832b. The electric machine 800 may include additional cooling mechanisms integrated with the first cooling system 830a and/or the second cooling system 830b, such as heat sinks, thermoelectric coolers, or forced-air fans, to further enhance a cooling performance of the electric machine 800.

In an embodiment of the present invention, the inner configuration and the outer configuration of the electric machine 800 may be similar to the inner configuration and the outer configuration as discussed above for the electric machines 100, 200, 300, 400, 500, 600, and 700.

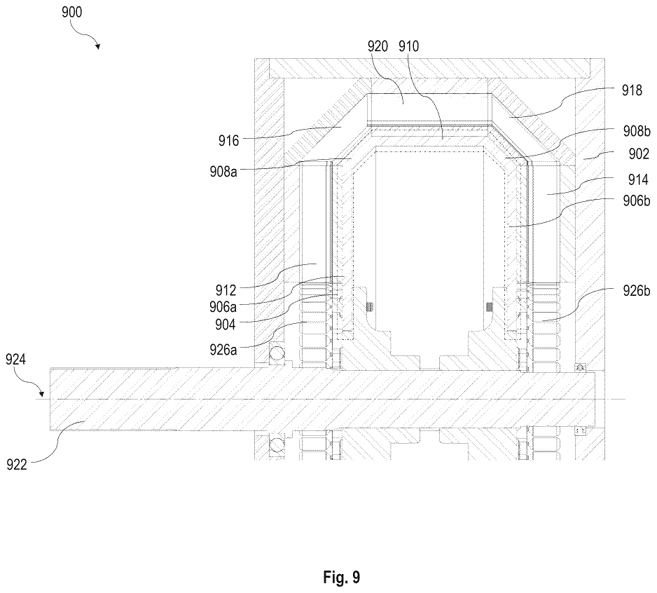

FIG. 9 illustrates a cross-sectional view of an electric machine 900 with an integrated inner rotating rotor, according to at least one embodiment of the present invention. The electric machine 900 (FIG. 9) may be an example of the electric machine 100 (FIG. 1).

The electric machine 900 may be a dual configuration of the electric machine 700 (FIG. 7) with the transition rotor mechanism in the inner rotating configuration. Further, the dual configuration may be achieved by means such as, but not limited to, welding, bolting, interlocking, and so forth. Embodiments of the present invention are intended to include or otherwise cover any suitable means, including known, related art, and/or later developed technologies for the achievement of the electric machine 900.

According to an embodiment of the present invention, the electric machine 900 may include a housing 902. The housing 902 may accommodate an integrated rotor 904 that may include a first axial rotor component 906a, a second axial rotor component 906b, a first transient rotor component 908a, a second transient rotor component 908b, and a radial rotor component 910.

According to at least one embodiment of the present invention, the first axial rotor component 906a may be magnetically coupled with a first axial stator component 912. The second axial rotor component 906b may be magnetically coupled with a second axial stator component 914. The first axial stator component 912 may be paired with a winding 926a, and the second axial stator component 914 may be paired with a winding 926b. The first transition rotor component 908a may be magnetically coupled with a first transition stator component 916. The second transition rotor component 908b may be magnetically coupled with a second transition stator component 918. The radial rotor component 910 may be magnetically coupled with a radial stator component 920, according to an embodiment of the present invention. The integrated rotor 904 may be disposed underneath the stator components such as the electric machine 900 may be in the inner rotating configuration, according to an embodiment of the present invention.

In another embodiment of the present invention, the stator components may be disposed underneath the integrated rotor 904 (not shown in the FIG. 9) such as the electric machine 900 may be in the outer rotating configuration.

The integrated rotor 904 may further be mechanically coupled with a shaft 922 (also referred to as a central shaft) for transmitting rotational motion. The shaft 922 may have an axis of rotation 924. The shaft 922 may act as a central axis for rotations of the integrated rotor 904. The shaft 922 may be arranged to support the integrated rotor 904 and to transmit mechanical power to an external system powered through the electric machine 900.

In an embodiment of the present invention, the inner configuration and the outer configuration of the electric machine 900 may be similar to the inner configuration and the outer configuration as discussed above for the electric machines 100, 200, 300, 400, 500, 600, 700, and 800.

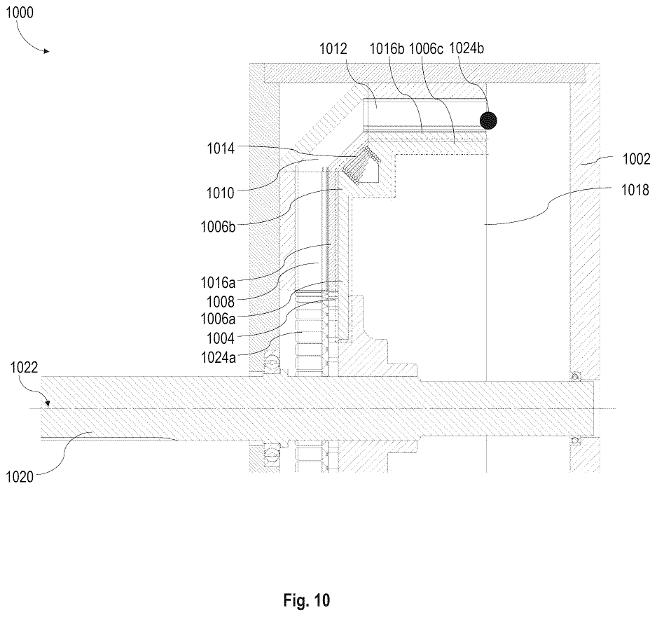

FIG. 10 illustrates a cross-sectional view of an electric machine 1000 with a hybrid wound rotor, according to at least one embodiment of the present invention. The electric machine 1000 may be an example of the electric machine 100 (FIG. 1).

The electric machine 1000 may include an external housing 1002. The external housing 1002 may be configured to accommodate an integrated rotor 1004. The integrated rotor 1004 may include an axial rotor component 1006a, a transition rotor component 1006b, and a radial rotor component 1006c. The external housing 1002 may be configured to accommodate stator components such as an axial stator component 1008, a transition stator component 1010, and a radial stator component 1012. The axial stator component 1008 may be paired with a winding 1024a, and radial stator component 1012 may be paired with a winding 1024b. The electric machine 1000 may further include a wound field 1014 that may be disposed between magnetic elements 1016a-1016b, according to an embodiment of the present invention. The wound field 1014 may include electrically conductive coils that may be wound to optimize electromagnetic coupling with the stator and rotor components.

The magnetic elements 1016a-1016b may be configured to generate the magnetic field in radial and/or axial directions of the electric machine 1000. Examples of such magnetic elements 1016a-1016b may include the rare-earth magnets like neodymium (NdFeB), samarium-cobalt (SmCo) magnets, ferrite magnets, alnico magnets, the electromagnets with coils wound around the ferromagnetic cores, and so forth. Embodiments of the present invention may be intended to include or otherwise cover any suitable type of the magnetic elements 1016a-1016b, including known, related art, and/or later developed technologies.

The electric machine 1000 may further include a controller 1018 that may be configured to control the operations of the axial components, radial components and/or transition components of the electric machine 1000. In at least one embodiment of the present invention, the controller 1018 may supervise distinct axial and radial controllers (not shown). The electric machine 1000 may further include a shaft 1020 that may be an example of the shaft 114 (FIG. 1). The shaft 1020 may have an axis of rotation 1022.

In an embodiment of the present invention, the inner configuration and the outer configuration of the electric machine 1000 may be similar to the inner configuration and the outer configuration as discussed above for the electric machines 100, 200, 300, 400, 500, 600, 700, 800, and 900.

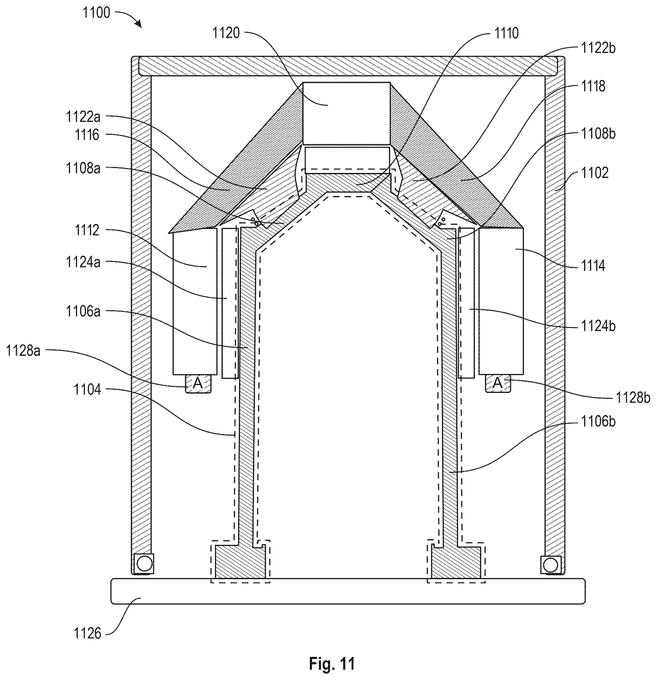

FIG. 11 illustrates a cross-sectional view of an electric machine 1100 with a hybrid wound rotor incorporated into an integrated dual rotor, according to at least one embodiment of the present invention.

The electric machine 1100 may be a dual configuration of the electric machine 1000 (FIG. 10) with the hybrid wound rotor. Further, the dual configuration may be achieved by means such as, but not limited to, welding, bolting, interlocking, and so forth. Embodiments of the present invention are intended to include or otherwise cover any suitable means, including known, related art, and/or later developed technologies, for dual configuration of the electric machine 1000 for achievement of the electric machine 1100.

The electric machine 1100 (FIG. 11) may be a further example of the electric machine 100 (FIG. 1). According to an embodiment of the present invention, the electric machine 1100 may include a housing 1102. The housing 1102 may accommodate an integrated rotor 1104 that may include a first axial rotor component 1106a, a second axial rotor component 1106b, a first transient rotor component 1108a, a second transient rotor component 1108b, and a radial rotor component 1110.

According to at least one embodiment of the present invention, the first axial rotor component 1106a may be magnetically coupled to a first axial stator component 1112. The second axial rotor component 1106b may be magnetically coupled to a second axial stator component 1114. The first axial stator component 1112 may be paired with a winding 1128a, and second axial stator component 1114 may be paired with a winding 1128b. The first transition rotor component 1108a may be magnetically coupled with a first transition stator component 1116. The second transition rotor component 1108b may be magnetically coupled with a second transition stator component 1118. The radial rotor component 1110 may be magnetically coupled with a radial stator component 1120, according to an embodiment of the present invention. The electric machine 1100 may further include wound fields 1122 that may be disposed between magnetic elements 1124a-1124b, according to an embodiment of the present invention. The wound fields 1122 may include the electrically conductive coils that may be wound to optimize the electromagnetic coupling with the stator and rotor components.

The integrated rotor 1104 may be disposed underneath the stator components such as the electric machine 1100 may be in the inner rotating configuration, according to an embodiment of the present invention. In another embodiment of the present invention, the stator components may be disposed underneath the integrated rotor 1104 (not shown in the FIG. 11) such as the electric machine 1100 may be in the outer rotating configuration.

The integrated rotor 1104 may further be mechanically coupled with a shaft 1126 for transmitting rotational motion. The shaft 1126 may act as a central axis for rotations of the integrated rotor 1104. The shaft 1126 may be arranged to support the integrated rotor 1104 and to transmit mechanical power to an external system powered through the electric machine 1100.

In an embodiment of the present invention, the inner configuration and the outer configuration of the electric machine 1100 may be similar to the inner configuration and the outer configuration as discussed above for the electric machines 100, 200, 300, 400, 500, 600, 700, 800, 900, and 1000.

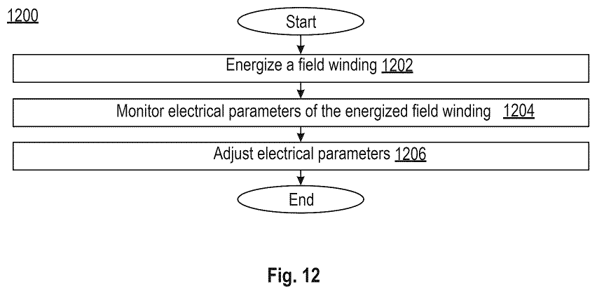

FIG. 12 illustrates a flowchart of a method 1200 of controlling one or more electric machines according to at least one embodiment of the present invention. It is to be understood that the method 1200 may be described in accordance with at least one embodiment of the present invention without direct reference to specific numerals of the components depicted corresponding to the one or more electric machines such as the electric machines 100, 200, 300, 400, 500, 600, 700, 800, 900, 1000, and 1100. The omission of specific numerals for components in describing the process 1200 may not limit the scope of the invention, and the process 1200 may be implemented using any suitable configuration or arrangement of the components described in the electric machines 100, 200, 300, 400, 500, 600, 700, 800, 900, 1000 and 1100.

At 1202 block, the field winding may be energized with a high-frequency field excitation supply including the at least one rotor-side component and at least one stator-side component. This step may involve delivering alternating current (AC) or other high-frequency signals to the field windings to create a dynamic magnetic field that may interact with the rotor and stator components. The rotor-side component may be mechanically coupled with the integrated rotor, and the stator-side component may be configured to ensure accurate delivery of the excitation signal for optimal magnetic coupling with the transition stator component situated between the axial and radial stator components.

At 1204 block, at least one electrical parameter of the energized field winding may be monitored. This monitoring may include measuring parameters such as current, voltage, resistance, or frequency using sensors or a controller. Data obtained by measuring the parameters may be analyzed to assess the stability and performance of the electric machine, particularly the magnetic interaction between the energized field winding, the integrated rotor, and the stator assembly. Any suitable irregularities or deviations in the monitored parameters may be utilized for benefit of corrective actions and/or to improve the performance of the electric machines.

At 1206 block, the at least one electrical parameter may be adjusted based on at least in part on the monitoring of the parameters. The adjustments may involve regulating the excitation supply or modifying operational parameters such as current amplitude, frequency, or duty cycle. The adjustment process may also consider additional factors, including the rotational speed of the integrated rotor, the torque, and load conditions of the electric machine. These changes may be implemented by the unified controller and/or the sub-controller to maintain efficient operation, optimize energy usage, and enable reliable performance of the electric machine under varying operating conditions.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electric machine, comprising:
a shaft having an axis of rotation;
an integrated rotor mechanically coupled with the shaft, the integrated rotor comprising an axial rotor component and a radial rotor component, wherein the axial rotor component is mechanically integrated with the radial rotor component such that the axial rotor component and the radial rotor component have a common angular velocity;
a stator assembly comprising an axial stator component, a radial stator component, and a transition stator component arranged at a first angle with respect to the axial stator component and at a second angle with respect to the radial stator component; and
a field winding mechanically coupled with the integrated rotor and configured to magnetically interact with the transition stator component.

2. The electric machine of claim 1, wherein the field winding is disposed between the radial rotor component and the shaft.

3. The electric machine of claim 1, wherein the integrated rotor further comprises a transition rotor component arranged at a third angle with respect to the axial rotor component and at a fourth angle with respect to the radial rotor component.

4. The electric machine of claim 3, wherein the integrated rotor is disposed between the field winding and the shaft.

5. The electric machine of claim 1, wherein the field winding is energized with a high frequency field excitation supply having at least one rotor-side component.

6. The electric machine of claim 1, wherein the field winding is energized with a power pick-up slip rings interface having at least one rotor-side component.

7. The electric machine of claim 1, further comprising an integrated winding for the axial stator component, the radial stator component and the transition stator component of the stator assembly.

8. The electric machine of claim 1, wherein the field winding is one field winding of a plurality of field windings mechanically coupled with the integrated rotor and the plurality of field windings are electrically coupled in series.

9. The electric machine of claim 1, wherein the axial rotor component is arranged at a third angle that is different from perpendicular to the axis of rotation to reduce ripple.

10. The electric machine of claim 1, wherein the radial rotor component is arranged at a fourth angle that is different from parallel to the axis of rotation to reduce ripple.

11. An electric machine, comprising:
a shaft having an axis of rotation;
a first integrated rotor mechanically coupled with the shaft, the first integrated rotor comprising a first axial rotor component and a first radial rotor component;
a second integrated rotor mechanically coupled with the shaft, the second integrated rotor comprising a second axial rotor component and a second radial rotor component;
a first stator assembly comprising a first axial stator component, a first radial stator component and a first transition stator component arranged at a first angle with respect to the first axial stator component and at a second angle with respect to the first radial stator component;
a second stator assembly comprising a second axial stator component, a second radial stator component and a second transition stator component arranged at a third angle with respect to the second axial stator component and at a fourth angle with respect to the second radial stator component;
a first field winding mechanically coupled with the first integrated rotor and configured to magnetically interact with the first transition stator component; and
a second field winding mechanically coupled with the second integrated rotor and configured to magnetically interact with the second transition stator component.

12. The electric machine of claim 11, wherein the first integrated rotor and the second integrated rotor are disposed between the first stator assembly and the second stator assembly.

13. The electric machine of claim 11, wherein:
the first radial rotor component and the second radial rotor component are mechanically integrated into a first integrated radial rotor component;
the first radial stator component and the second radial stator component are mechanically integrated into a first integrated radial stator component; and
the first integrated radial rotor component is disposed between the shaft and the integrated radial stator component.

14. The electric machine of claim 11, wherein the first integrated rotor and the second integrated rotor are configured to have a common angular velocity.

15. The electric machine of claim 11, wherein the first axial rotor component is arranged at a fifth angle that is different from perpendicular to the axis of rotation to reduce ripple.

16. The electric machine of claim 11, wherein the first radial rotor component is arranged at a sixth angle that is different from parallel to the axis of rotation to reduce ripple.

17. The electric machine of claim 11, wherein the first field winding is energized with a high frequency field excitation supply having at least one rotor-side component.

18. A method of controlling an electric machine, comprising:
energizing a field winding mechanically coupled with an integrated rotor and configured to magnetically interact with a transition stator component disposed between an axial stator component and a radial stator component of a stator assembly;
monitoring at least one electrical parameter of the energized field winding; and
adjusting the at least one electrical parameter based at least in part on the monitoring.

19. The method of claim 18, wherein:
the field winding is energized with a high frequency field excitation supply having at least one rotor-side component and at least one stator-side component; and
the monitoring and the adjusting is performed at least in part by a controller in electrical communication with the at least one stator-side component.

20. The method of claim 18, wherein adjusting the at least one electrical parameter is further based on one or more of: a rotational speed of the integrated rotor, a torque of the electric machine and a load condition of the electric machine.
